(19) United States
(12) Patent Application Publication
(10) Pub. No.: US 2023/0239813 A1
(43) Pub. Date: Jul. 27, 2023

(54) POWER ENHANCEMENT FOR TRANSMISSION WITH SURVIVAL TIME REQUIREMENT

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Rajat PRAKASH, San Diego, CA (US); Hao XU, Beijing (CN)

(21) Appl. No.: 18/001,768

(22) PCT Filed: Aug. 25, 2020
(86) PCT No.: PCT/CN2020/111008

§ 371 Date: Dec. 14, 2022

(51) Int. Cl. H04W 52/48; H04W 52/36

(52) U.S. Cl. CPC H04W 52/48; H04W 52/36

(57) ABSTRACT

Various aspects of the present disclosure generally relate to wireless communication. In some aspects, a source device may determine a transmit power level increase based at least in part on a failed transmission for a message having a deadline for reception at a target device. For example, in some aspects, the deadline for reception of the message may be based at least in part on a survival time for an application consuming a communication service associated with the message. The source device may transmit a next message using the transmit power level increase during the survival time and prior to the deadline for reception of the message at the target device. Numerous other aspects are provided.

### FIELD OF THE DISCLOSURE

Aspects of the present disclosure generally relate to wireless communication and to techniques and apparatuses for power enhancement for transmission with survival time requirement.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a source device may include: determining a transmit power level increase based at least in part on a failed transmission for a message having a deadline for reception at a target device, wherein the deadline for reception of the message is based at least in part on a survival time for an application consuming a communication service associated with the message; and transmitting a next message using the transmit power level increase during the survival time and prior to the deadline for reception of the message at the target device.

In some aspects, a source device for wireless communication includes a memory and one or more processors operatively coupled to the memory. The memory and the one or more processors may be configured to: determine a transmit power level increase based at least in part on a failed transmission for a message having a deadline for reception at a target device, wherein the deadline for reception of the message is based at least in part on a survival time for an application consuming a communication service associated with the message; and transmit a next message using the transmit power level increase during the survival time and prior to the deadline for reception of the message at the target device.

In some aspects, a non-transitory computer-readable medium storing a set of instructions for wireless communication includes one or more instructions that, when executed by one or more processors of a source device, cause the source device to: determine a transmit power level increase based at least in part on a failed transmission for a message having a deadline for reception at a target device, wherein the deadline for reception of the message is based at least in part on a survival time for an application consuming a communication service associated with the message; and transmit a next message using the transmit power level increase during the survival time and prior to the deadline for reception of the message at the target device.

In some aspects, an apparatus for wireless communication includes: means for determining a transmit power level increase based at least in part on a failed transmission for a message having a deadline for reception at a target device, wherein the deadline for reception of the message is based at least in part on a survival time for an application consuming a communication service associated with the message; and means for transmitting a next message using the transmit power level increase during the survival time and prior to the deadline for reception of the message at the target device.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIGS. 3A-3B are diagrams illustrating examples of wireless communication associated with a survival time, in accordance with various aspects of the present disclosure.

FIGS. 4A-4B are diagrams illustrating examples associated with power enhancement for transmission with survival time requirement, in accordance with various aspects of the present disclosure.

FIG. 5 is a diagram illustrating an example process associated with power enhancement for transmission with survival time requirement, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

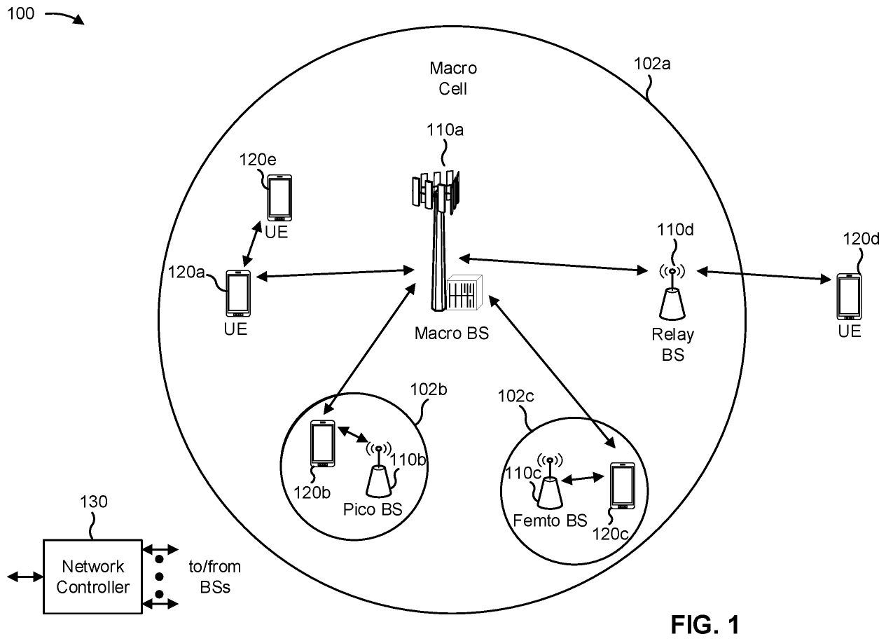

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

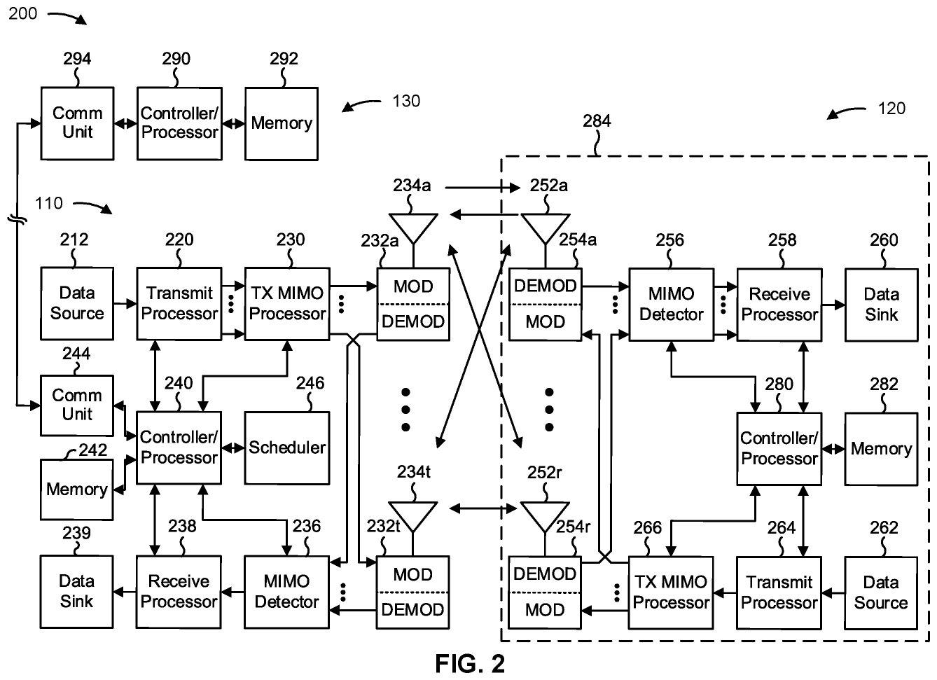

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

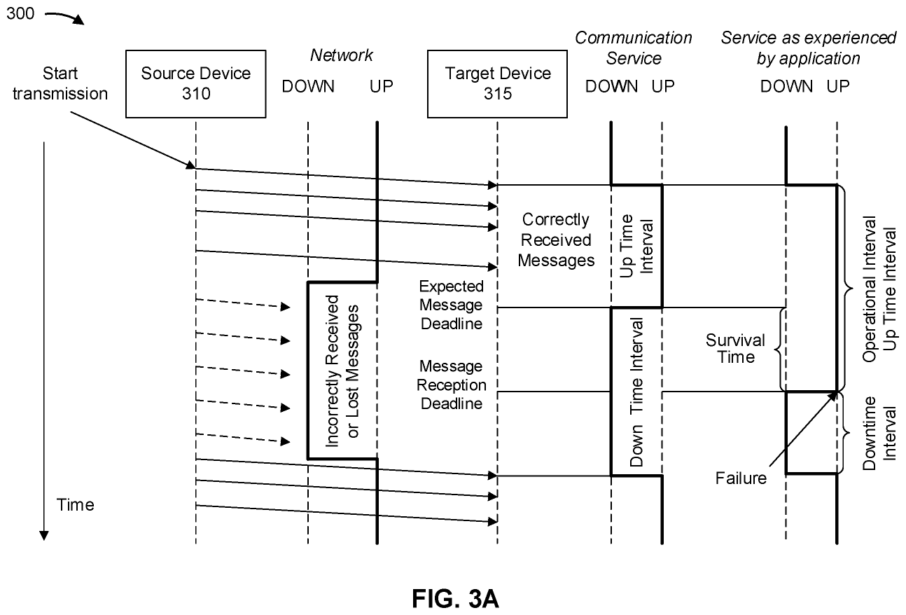

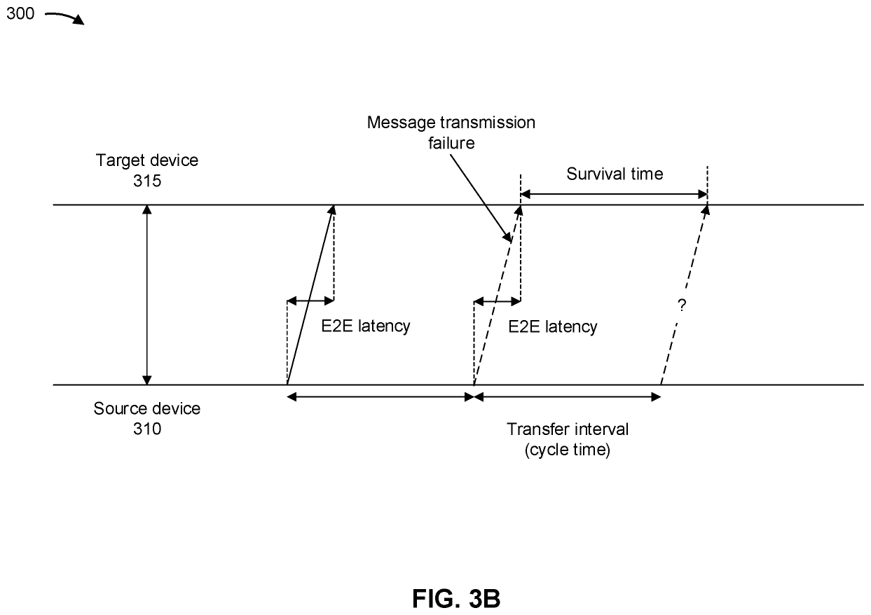

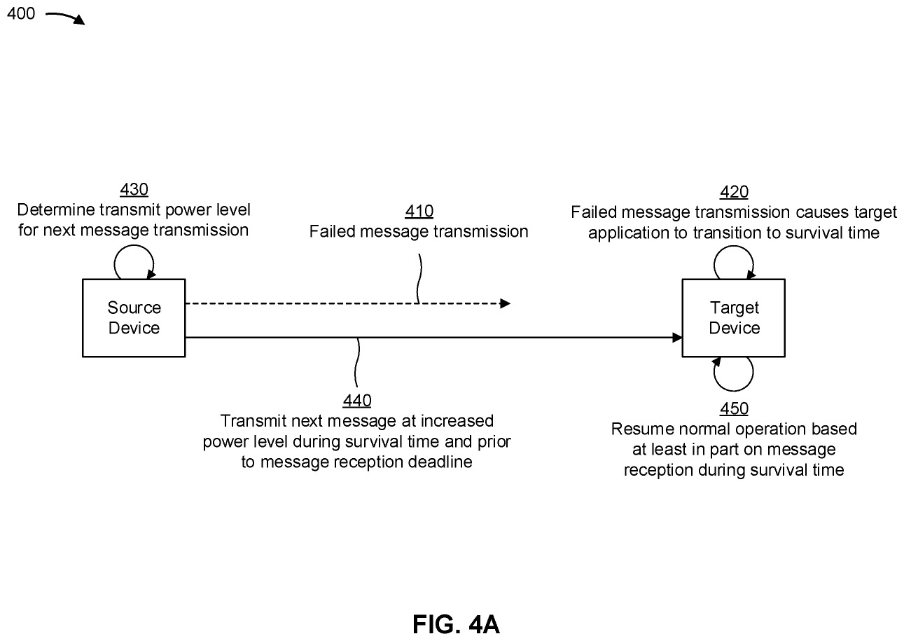

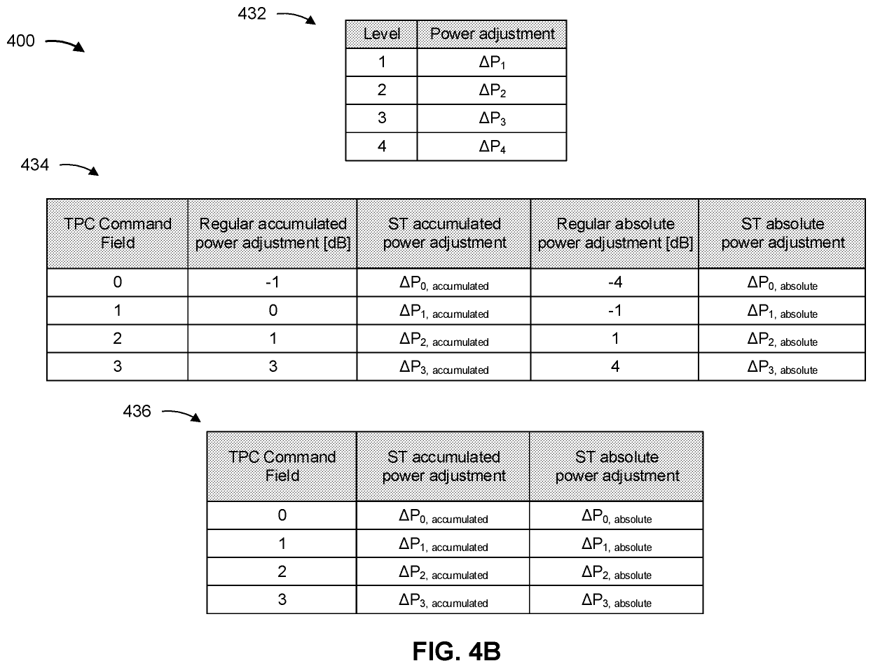

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3A-3B, FIGS. 4A-4B, and/or FIG. 4.

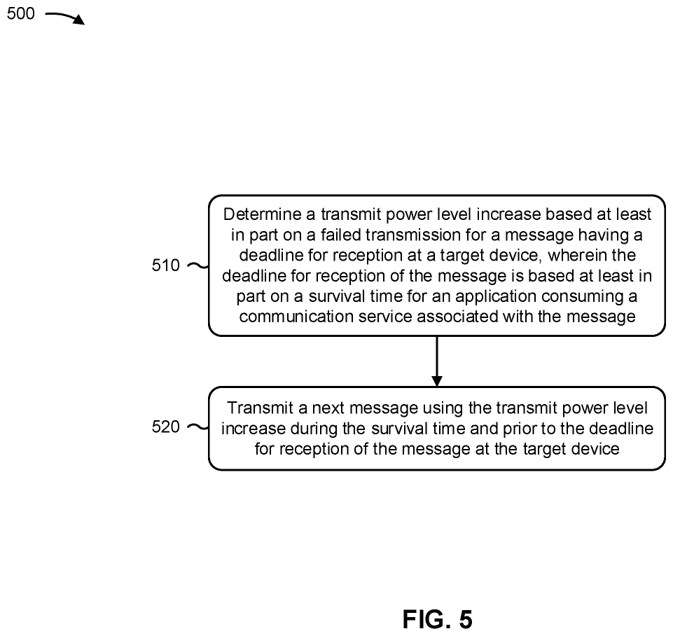

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3A-3B, FIGS. 4A-4B, and/or FIG. 5.

Controller/processor 240 of base station 110, controller/processor 280 of UE 120, and/or any other component(s) of FIG. 2 may perform one or more techniques associated with power enhancement for transmission with survival time requirement, as described in more detail elsewhere herein. For example, controller/processor 240 of base station 110, controller/processor 280 of UE 120, and/or any other component(s) of FIG. 2 may perform or direct operations of, for example, process 500 of FIG. 5 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 500 of FIG. 5 and/or other processes as described herein. In some aspects, executing instructions may include running the instructions, converting the instructions, compiling the instructions, interpreting the instructions, and/or the like.

In some aspects, UE 120 may include means for determining a transmit power level increase based at least in part on a failed transmission for a message having a deadline for reception at a target device (e.g., base station 110), wherein the deadline for reception of the message is based at least in part on a survival time for an application consuming a communication service associated with the message, means for transmitting a next message using the transmit power level increase during the survival time and prior to the deadline for reception of the message at the target device, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

FIGS. 3A-3B are diagrams illustrating examples 300 of wireless communication associated with a survival time, in accordance with various aspects of the present disclosure. As shown in FIGS. 3A-3B, a source device 310 and a target device 315 may communicate in a wireless network (e.g., wireless network 100). For example, as described in further detail herein, the source device 310 may transmit messages associated with a delay-sensitive communication service to the target device 315, which may be executing an application that consumes the delay-sensitive communication service. For example, in some aspects, the delay-sensitive communication service may include any suitable service associated with a message reception deadline, such as an ultra-reliable low-latency communication (URLLC) service associated with an automation system, a motion control service that controls moving and/or rotating machine parts, and/or the like.

As described herein, the application at the target device that consumes the delay-sensitive communication service may be associated with a survival time, which generally refers to a maximum time period that an application consuming a communication service can continue without an anticipated message, a maximum number of consecutive messages that can be incorrectly received or lost, and/or the like. Accordingly, in cases where the survival time is exceeded, the application may cause the associated communication service to transition to a down state.

For example, as shown in FIG. 3A, messages transmitted by the source device 310 may be correctly received by the target device 315 (e.g., received and successfully decoded), incorrectly received by the target device 315 (e.g., received and unsuccessfully decoded due to corruption, over-the-air errors, and/or the like), or lost in transit to the target device 315 (e.g., due to obstructions or blockage in a wireless channel, beam failure, and/or the like). For example, as shown in FIG. 3A, messages may be successfully transmitted (e.g., correctly received by the target device 315) when the network is in an up state or an available state (shown as “UP” in FIG. 3A). Message transmissions may fail when the messages are incorrectly received by the target device 315 or lost in transit to the target device 315. In such cases, where the network can no longer support end-to-end transmission of the messages from the source device 310 to the target device 315 according to a negotiated quality of service (QoS), such as an end-to-end-latency, the network may transition to a down state or an unavailable state (shown as “DOWN” in FIG. 3A). Therefore, the communication service is in an up state for an up time interval when anticipated messages are correctly received by the target device 315 and is in a down state for a down time interval when messages are incorrectly received and/or lost (e.g., not received) by the target device 315.

In some aspects, as described herein, the application executed by the target device 315 and a corresponding application executed by the source device 310 may be sensitive to delay. Accordingly, the messages may be time-sensitive for particular operations such that the application transitions to a downtime or failure state when a deadline for message reception is not met. For example, as shown in FIG. 3A, the application executing on the target device 315 may detect the absence of an anticipated or otherwise expected message when the expected message is not received by an expected deadline (shown as “Expected Message Deadline” in FIG. 3A). However, to avoid or reduce a non-operational or otherwise unavailable state, the application may wait a certain duration before the communication service is considered to be unavailable. For example, the expected message may be associated with a reception deadline (shown as “Message Reception Deadline” in FIG. 3A), and a time period between the expected deadline for the message and the reception deadline for the message may be referred to as the survival time. In some aspects, the survival time can be expressed as a time period or, especially with cyclic traffic, as a maximum number of consecutive incorrectly received or lost messages. If the survival time is exceeded, the application transitions the status of the communication service to a down state. For example, in FIG. 3A, the bolded line showing the status of the application (“service as experienced by application”) changes to DOWN when the survival time is exceeded.

In some cases, as shown in FIG. 3B, the application executing on the target device 315 may be associated with a stringent delay-sensitive use case (e.g., motion control and/or the like) with periodic communications. In such cases, the survival time may be related (e.g., equivalent to) a transfer interval, which generally refers to the elapsed time between any two consecutive periodic communications that are delivered from the source device 310 to an ingress point of a communication system (e.g., the wireless network over which the source device 310 and the target device 315 are communicating). For example, as shown in FIG. 3B, the source device 310 may transmit a message at a first time, and the message may be received at the target device 315 at a second time that depends on an end-to-end latency between the source device 310 and the target device 315. Furthermore, after a transfer interval has elapsed, the source device 310 may transmit a next periodic message to the target device 315. In this case, however, the next periodic message transmission may fail (e.g., be incorrectly received by the target device 315 or lost in transit to the target device 315), which may cause the target device 315 to transition the delay-sensitive application to a survival time. Accordingly, the survival time may be related to the transfer interval (e.g., a cycle time for cyclic or periodic traffic between the source device 310 and the target device 315) for a single message transmission failure. For example, the survival time may be exceeded if the target device 315 does not successfully receive a retransmission of the incorrectly received and/or lost message before a time when a next message transmission is anticipated, where the survival time is based at least in part on the end-to-end latency (e.g., the difference between the transmission time and reception time of a message) and the transfer interval between periodic message transmissions.

In cases where the survival time is exceeded and the application at the target device 315 transitions to a down state, an unavailable state, a failure state, and/or the like, the application may implement one or more actions to handle the unavailable communication service. For example, in some cases, the application may commence an emergency shutdown, whereby the application transitions to a safe state in which the target application may continue to listen for incoming packets (e.g., to resume the operational state), attempt to send messages to the source device 310 (e.g., to indicate non-reception or incorrect reception of one or more messages). When the network and/or communication service returns to the up state, the communication service state as experienced by the target application may return to the up state. Accordingly, the communication service may again be considered available or otherwise operational when a message is correctly received by the application at the target device 315.

In general, to avoid a potential downtime interval due to the survival time expiring before an anticipated message is received, recovery measures may be implemented during the survival time in order to increase a probability that a retransmission will be correctly received at the target device 315 prior to the survival time expiring (e.g., prior to the message reception deadline). For example, in cases where the source device 315 is a base station and the target device 315 is a UE (e.g., the source device 315 is transmitting downlink messages to the target device 315), the base station may autonomously implement scheduling measures to increase the probability that a retransmission will be correctly received at the UE during the survival time, upon determining that the survival time has started for the application at the target device 315 (e.g., based on a negative acknowledgement (NACK) from the target device 315, a lack of an acknowledgement (ACK) from the target device 315, and/or the like). For example, the base station may increase a downlink transmit power, use a lower modulation and coding scheme (MCS), increase a resource size, and/or the like.

However, for uplink communications in cases where the source device 315 is a UE and the target device 315 is a base station, the UE may be limited in the remedial measures that can be taken to improve the probability that a retransmission will be correctly received at the base station during the survival time. For example, the UE cannot change an uplink MCS or an uplink resource size without a dynamic scheduling assignment or scheduling grant from the base station. Additionally, or alternatively, the UE may be restricted with respect to increasing an uplink transmit power (e.g., to avoid causing interference with other uplink and/or downlink transmissions, to comply with maximum permissible exposure limits, to conserve battery power, and/or the like).

For example, a base station typically uses one or more downlink control information (DCI) formats to control uplink transmit power, but such DCI formats are not designed to increase wireless link reliability during an application-specific (or service-specific) survival time. For example, DCI formats 1_0 and 1_1 can be used to adjust a physical uplink control channel (PUCCH) transmit power and DCI formats 0_0 and 0_1 can be used to adjust a physical uplink shared channel (PUSCH) transmit power, but these DCI formats are only suitable in cases where there is a dynamic scheduling assignment or scheduling grant. Furthermore, DCI format 2_2 can be used to carry a transmit power control (TPC) command for UEs with a semi-persistent scheduling (SPS) configuration as a complement to power control commands provided in downlink and/or uplink assignments. However, DCI format 2_2 is used to control PUCCH and PUSCH transmit power for SPS transmissions because SPS transmissions are not associated with dynamic scheduling in which TPC commands are typically indicated. Furthermore, DCI format 2_3 can be used to carry a TPC command for sounding reference signal (SRS) transmissions when SRS and PUSCH power controls are decoupled (e.g., because independent power control is desired, a UE is not configured with a PUSCH or PUCCH, such as for a supplemental uplink, and/or the like). Accordingly, existing DCI formats are unsuitable to control a UE transmit power to increase a probability that a message retransmission is successfully received at a base station before a survival time expiring, which may lead to service discontinuity, decreased reliability, increased latency, greater resource consumption, and/or the like.

Some aspects described herein relate to techniques and apparatuses to determine a suitable transmit power level to be applied when a source device performs a transmission (e.g., a retransmission) associated with a survival time requirement. In some aspects, a source device may determine a transmit power level increase to be applied for a transmission during a survival time based at least in part on a failed transmission for a message having a deadline for reception at a target device. For example, in some aspects, the source device may be configured with a set of power level adjustments that have different delta values, and the source device may select one of the power level adjustments based on a number of transmissions that have been attempted during the survival time, a maximum number of transmissions that are allowed during the survival time, a duration of the survival time, and/or the like. Additionally, or alternatively, the UE may receive a TPC command from the target device (e.g., in a DCI message, a medium access control (MAC) control element (MAC-CE), and/or the like), and the TPC command may indicate the power level adjustment to be applied for the survival time transmission. Accordingly, the source device may retransmit the failed message, transmit a next message, and/or the like using the transmit power level increase during the survival time and prior to the message reception deadline. In this way, the source device may increase the transmit power level for the message transmission, and thereby increase reliability of a wireless link for one or more traffic flows associated with the failed message transmission. In this way, the probability that the next transmission is successfully received by the target device within an end-to-end latency budget is improved, which may enable the application to return to normal operation and avoid a downtime interval or unavailable time. In this way, wireless communication between the source device and the target device may be associated with greater service continuity, increased reliability, reduced latency, reduced resource consumption, and/or the like.

As indicated above, FIGS. 3A-3B are provided as examples. Other examples may differ from what is described with regard to FIGS. 3A-3B.

FIGS. 4A-4B are diagrams illustrating examples 400 associated with power enhancement for transmission with survival time requirement, in accordance with various aspects of the present disclosure. As shown in FIGS. 4A-4B, example(s) 400 include communication between a source device (e.g., a UE) and a target device (e.g., a base station) in a wireless network (e.g., wireless network 100). Furthermore, the source device may transmit messages associated with a communication service to the target device, which may be executing an application that consumes the communication service. The communication service may be associated with a message reception deadline, and the application consuming the communication service may be associated with a survival time (e.g., a timer or a counter) that may generally start when the target device incorrectly receives and/or does not receive an expected message by an expected message deadline, as described in further detail above with reference to FIGS. 3A-3B.

As shown in FIG. 4A, and by reference number 410, the source device may attempt to transmit a message to the target device, and the attempted message transmission may fail. For example, in some cases, the attempted message transmission may fail when the message is incorrectly received at the target device (e.g., where the target device receives the message but is unable to successfully decode the message due to corruption, over-the-air errors, path loss leading to a reduction in received signal strength or received signal quality, and/or the like). Alternatively, in some cases, the attempted message transmission may fail when the message is lost in transit to the target device (e.g., where the message never reaches the target device due to network unavailability, obstructions in a wireless channel between the source device and the target device, and/or the like). In some aspects, the message that the source device attempts to transmit may be an uplink message, such as a PUCCH transmission, a PUSCH transmission, an SRS transmission, and/or the like. Furthermore, in some aspects, the uplink message may be associated with an expected reception deadline (e.g., a time at which the message is expected to arrive at the target device).

Accordingly, as further shown in FIG. 4A, and by reference number 420, the failed message transmission may cause the target device to transition a target application that is consuming a communication service associated with the failed message transmission to a survival time. In some aspects, the survival time may start when the target device detects the absence of an anticipated or expected message (e.g., an expected message is not received prior to an expected message deadline). For example, as described above, the survival time may be expressed as a maximum time period (e.g., a maximum duration), or a maximum number of consecutive messages that can be incorrectly received or lost before the target application transitions the associated communication service to a down state, a failure state, and/or the like. In some aspects, the survival time may have a value that depends on an end-to-end latency budget, a negotiated quality of service, a scheduling constraint, and/or other metrics that relate to continuity, reliability, availability, and/or the like for the associated communication service. Furthermore, in some aspects, the target device may transmit feedback to the source device to indicate that the message transmission failed. For example, in some aspects, the target device may transmit NACK feedback to the source device to indicate that the message was incorrectly received or lost. Additionally, or alternatively, the target device may transmit a TPC command to the source device to indicate a transmit power adjustment to be applied to one or more retransmissions during the survival time. However, in some cases, the NACK feedback transmitted by the target device may be lost or incorrectly received by the source device (e.g., for similar reasons that caused the failure of the message transmission to the target device).

Accordingly, as further shown in FIG. 4A, and by reference number 430, the source device may be configured to employ one or more techniques to determine a transmit power level to be used to for a next message transmission (e.g., a retransmission of the message that was lost or incorrectly received by the target device). For example, in some cases, the source device may determine that the message transmission failed based at least in part on NACK feedback from the target device, a lack of ACK feedback from the target device, and/or the like. Accordingly, as described herein, the source device may determine the transmit power level to be used to transmit the next message in order to increase a probability that the next message is correctly received at the target device during the survival time and prior to the deadline for reception of the message. In this way, the source device may adjust the transmit power level to increase reliability of the wireless link between the source device and the target device such that the next message reaches the target device within the overall end-to-end latency budget and the application can resume normal operation. In this way, the source device and the target device may reduce service discontinuity, unreliability, latency, resource consumption, and/or the like that may otherwise occur in cases where the communication service transitions to an unavailable or down state because the message is not correctly received before the survival time is exceeded.

For example, in some aspects, the source device may determine the transmit power level for the next message transmission based at least in part on a set of power adjustments that can be applied during an application survival time that starts when one or more anticipated or expected messages are incorrectly received or not received by the target device. For example, as shown in FIG. 4B, and by reference number 432, the source device may be configured with multiple power adjustments that each have a corresponding level, which may be indicated to the source device (e.g., in radio resource control (RRC) signaling and/or the like), defined in a wireless communication standard, and/or the like. In general, each power adjustment may be defined as a change in transmit power to be applied at a corresponding level (e.g., ΔPₙ, where n is the level of the power adjustment, and where ΔPₙ<ΔPₙ₊₁). For example, in cases where four power adjustment levels are configured, ΔP₁<ΔP₂<ΔP₃<ΔP₄. Accordingly, at the higher power adjustment level(s), the transmit power may be increased more aggressively to increase the probability that the message will be correctly received by the target device before the deadline for reception of the message (e.g., before the survival time expires or is otherwise exceeded).

In some aspects, the source device may determine the level of the power adjustment to be applied for the transmission according to a number of times that a message has been previously transmitted during the survival time, a maximum number of transmissions and/or retransmissions allowed during the survival time, a length or duration of the survival time, and/or the like. For example, in some cases, the source device may be permitted to transmit only one package (e.g., transport block) during a particular survival time, and there may be a maximum number of retransmissions allowed during the survival time. Accordingly, in some aspects, the level of the power adjustment used for a particular transmission or retransmission may depend on how many times the package has been previously transmitted, how many retransmission opportunities are remaining in the current survival time, and/or the like. For example, in cases where four power adjustment levels are configured and the maximum number of retransmissions is four, a first retransmission (e.g., when the package has previously been retransmitted zero times) may use the level 1 power adjustment (ΔP₁), and a fourth retransmission may use the level 4 power adjustment (ΔP₄). In another example, where the maximum number of retransmissions is two, the first retransmission may use the level 2 power adjustment (ΔP₂) and the fourth retransmission may use the level 4 power adjustment (ΔP₄). In other words, each retransmission may use a different power adjustment level, with the lower power adjustment level(s) used when the survival time has more retransmission opportunities after the current retransmission and the higher power adjustment level(s) used as the retransmission opportunities are approaching exhaustion.

Additionally, or alternatively, as described above, the source device may determine the level of the power adjustment to be applied for the transmission according to the length or duration of the survival time, which may determine the maximum number of retransmission opportunities that are allowed or available during the survival time for a last transmission. For example, if the length of the survival time allows four packages to be transmitted, and no retransmissions are allowed for the fourth package, then the highest power adjustment level may be applied for the fourth package. More generally, if the length of the survival time allows N packages to be transmitted, and no retransmissions are allowed for the final package, then the highest power adjustment level may be applied for the Nth package. In another example, if two retransmissions are allowed for the final package, then the second highest power adjustment level may be applied for the first retransmission of the final package and the highest power adjustment level may be applied for the second retransmission of the final package. In some aspects, in cases where the power adjustment level is determined according to the length or duration of the survival time, the power adjustment level may be applied only for a last retransmission that occurs during the survival time (e.g., where M retransmissions are allowed, the first M−1 retransmissions may be performed at a normal transmit power level to conserve resources of the source device, reduce interference with other transmissions, and/or the like).

Additionally, or alternatively, in some aspects, the source device may determine the transmit power level for the message transmission based at least in part on a TPC command received from the target device. For example, as further shown in FIG. 4B, and by reference number 434, the TPC command may include a TPC command field that has two bits to indicate one of four possible values, and each value may be associated with a set of power adjustment values. For example, the power adjustment values may include a first power adjustment to be applied to a regular transmission (e.g., during normal operation) when TPC for the source device is configured in an accumulated mode, and a second power adjustment to be applied to a regular transmission when TPC for the source device is configured in an absolute mode. In addition, the power adjustment values associated with each possible value of the TPC command may include a first power adjustment to be applied to a transmission associated with a survival time requirement when TPC for the source device is configured in the accumulated mode, and a second power adjustment to be applied to a transmission associated with a survival time requirement when TPC for the source device is configured in the absolute mode. Accordingly, because there may be ambiguity as to which power adjustment is to be applied (e.g., regular or survival time), various techniques may be used to determine which power adjustment is to be applied.

For example, in some aspects, the source device may autonomously select whether to use the regular power adjustment or the survival time power adjustment that is associated with the two-bit indicator provided in the TPC command field. For example, the source device may select the regular power adjustment when the current transmission (or retransmission) is not associated with a survival time requirement, when there are remaining retransmission opportunities, and/or the like. In other examples, the source device may select the survival time power adjustment when the current transmission (or retransmission) is associated with a survival time requirement, when the retransmission opportunities have been exhausted, and/or the like. Alternatively, in some aspects, the target device may indicate whether the source device is to use the regular power adjustment or the survival time power adjustment associated with the indicator provided in the TPC command field. For example, in some aspects, an additional bit may be provided in the TPC command field (or a separate field) to indicate whether the TPC command is for a regular power adjustment or a survival time power adjustment (e.g., a first value, such as ‘0’, may indicate that the TPC command is for a regular power adjustment, and a second value, such as ‘1’, may indicate that the TPC command is for a survival time power adjustment). In some aspects, the TPC command may be indicated as a survival time power adjustment based at least in part on the source device transmitting, to the target device, a scheduling request to indicate that a (re)transmission is associated with a survival time requirement. In such cases, the target device may transmit a subsequent TPC command to switch back to regular power adjustments after receiving another scheduling request related to a regular transmission. Alternatively, in some aspects, the target device may transmit, to the source device, a MAC-CE to indicate whether the TPC command is for survival time or regular transmissions. In this case, the TPC command may not need to have an extra bit to indicate whether the TPC command is for survival time or regular transmissions, which may reduce signaling overhead, implementation complexity, and/or the like.

Additionally, or alternatively, in some aspects, the source device may determine the transmit power level for the transmission of the message based at least in part on a DCI message that has a format associated with indicating a TPC command to be used for a transmission associated with a survival time requirement. For example, in some aspects, the DCI message may have a similar structure as DCI format 2_2 that is used to indicate a PUCCH TPC command or a PUSCH TPC command (e.g., for transmissions associated with an SPS configuration). For example, as further shown in FIG. 4B, and by reference number 436, the TPC command may have similar fields as the TPC command shown by reference number 434, except the TPC command includes only survival time power adjustment values. In general, the TPC command may include N bits to indicate one of up to 2^{N} possible values. For example, as shown, the TPC command field may have four (2²) possible values, whereby the TPC command field may include two bits to indicate one of the four possible values.

In some case, the DCI message that carries the TPC command may be scrambled by a radio network temporary identifier (RNTI) that is associated with indicating a survival time TPC command. For example, the DCI message may be scrambled with a TPC-PUSCH-ST-RNTI in cases where the TPC command is for a PUSCH transmission with a survival time requirement, a TPC-PUCCH-ST-RNTI in cases where the TPC command is for a PUCCH transmission with a survival time requirement, and/or the like. In some aspects, the DCI message may have a group common format to enable the target device to concurrently schedule a TPC for a group of source devices. In such cases, the DCI message may be provided to multiple source devices associated with a block number for an uplink in a cell associated with the target device, and one or more RRC parameters may be used to indicate an index to the block number associated with the source device. For example, the RRC parameters may include a first RRC parameter for control channel transmissions (e.g., tpc-PUCCH-st), a second RRC parameter for data channel transmissions (e.g., tpc-PUSCH-st), and/or the like.

In some aspects, as shown in FIG. 4A, and by reference number 440, the source device may transmit a next message (e.g., a retransmission of the message that previously failed) at an increased power level during the survival time and prior to the deadline for reception of the message at the target device. For example, the source device may determine the increased power level at which to transmit the message, as described above. In some aspects, as further shown in FIG. 4A, and by reference number 450, the application executing at the target device may resume normal operation based at least in part on receiving the message during the survival time and prior to the message reception deadline. For example, as described above, the increased power level at which the source device retransmits the message may increase a likelihood that the message will reach the target device correctly prior to the message reception deadline, prior to exceeding the survival time, and/or the like. In this way, the communication service may resume normal operation and a failure state or downtime interval may be avoided. In this way, the communication service may experience improved continuity, improved reliability, reduced latency, reduced resource consumption, and/or the like.

As indicated above, FIGS. 4A-4B are provided as examples. Other examples may differ from what is described with regard to FIGS. 4A-4B.

FIG. 5 is a diagram illustrating an example process 500 performed, for example, by a source device, in accordance with various aspects of the present disclosure. Example process 500 is an example where the source device (e.g., UE 120, source device 310, and/or the like) performs operations associated with power enhancement for transmission with survival time requirement.

As shown in FIG. 5, in some aspects, process 500 may include determining a transmit power level increase based at least in part on a failed transmission for a message having a deadline for reception at a target device, wherein the deadline for reception of the message is based at least in part on a survival time for an application consuming a communication service associated with the message (block 510). For example, the source device may determine (e.g., using controller/processor 280, memory 282, and/or the like) a transmit power level increase based at least in part on a failed transmission for a message having a deadline for reception at a target device, as described above. In some aspects, the deadline for reception of the message is based at least in part on a survival time for an application consuming a communication service associated with the message.

As further shown in FIG. 5, in some aspects, process 500 may include transmitting a next message using the transmit power level increase during the survival time and prior to the deadline for reception of the message at the target device (block 520). For example, the source device may transmit (e.g., using controller/processor 280, transmit processor 264, TX MIMO processor 266, MOD 254, antenna 252, memory 282, and/or the like) a next message using the transmit power level increase during the survival time and prior to the deadline for reception of the message at the target device, as described above.

Process 500 may include additional aspects, such as any single aspect or any combination of aspects described below and/or in connection with one or more other processes described elsewhere herein.

In a first aspect, the transmit power level increase is applied only for a last transmission during the survival time.

In a second aspect, alone or in combination with the first aspect, the transmit power level increase is selected from multiple values for the transmit power level increase based at least in part a number of transmissions that have been attempted during the survival time.

In a third aspect, alone or in combination with one or more of the first and second aspects, the transmit power level increase is selected from multiple values for the transmit power level increase based at least in part a duration of the survival time.

In a fourth aspect, alone or in combination with one or more of the first through third aspects, the transmit power level increase is selected from multiple values for the transmit power level increase based at least in part a maximum number of retransmissions that are allowed during the survival time.

In a fifth aspect, alone or in combination with one or more of the first through fourth aspects, the transmit power level increase is based at least in part on a regular power adjustment value or a survival time power adjustment value associated with a TPC command from the target device.

In a sixth aspect, alone or in combination with one or more of the first through fifth aspects, the source device autonomously selects either the regular power adjustment value or the survival time power adjustment value associated with the TPC command to be used as the transmit power level increase.

In a seventh aspect, alone or in combination with one or more of the first through sixth aspects, the source device selects either the regular power adjustment value or the survival time power adjustment value associated with the TPC command to be used as the transmit power level increase based at least in part on an indicator received from the target device.

In an eighth aspect, alone or in combination with one or more of the first through seventh aspects, the indicator is a bit in the TPC command.

In a ninth aspect, alone or in combination with one or more of the first through eighth aspects, the indicator is included in a MAC-CE received from the target device.

In a tenth aspect, alone or in combination with one or more of the first through ninth aspects, the transmit power level increase is based at least in part on DCI that includes a TPC command to indicate a survival time power adjustment value.

In an eleventh aspect, alone or in combination with one or more of the first through tenth aspects, the DCI is scrambled by an RNTI associated with indicating a survival time TPC command.

In a twelfth aspect, alone or in combination with one or more of the first through eleventh aspects, the DCI has a group common DCI format to schedule the transmit power level increase for multiple source devices associated with a block number for an uplink in a cell associated with the target device.

In a thirteenth aspect, alone or in combination with one or more of the first through twelfth aspects, the TPC command includes one or more bits to indicate the survival time power adjustment value.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a source device, comprising:
determining a transmit power level increase based at least in part on a failed transmission for a message having a deadline for reception at a target device, wherein the deadline for reception of the message is based at least in part on a survival time for an application consuming a communication service associated with the message; and
transmitting a next message using the transmit power level increase during the survival time and prior to the deadline for reception of the message at the target device.

2. The method of claim 1, wherein the transmit power level increase is applied only for a last transmission during the survival time.

3. The method of claim 1, wherein the transmit power level increase is selected from multiple values for the transmit power level increase based at least in part a number of transmissions that have been attempted during the survival time.

4. The method of claim 1, wherein the transmit power level increase is selected from multiple values for the transmit power level increase based at least in part a duration of the survival time.

5. The method of claim 1, wherein the transmit power level increase is selected from multiple values for the transmit power level increase based at least in part a maximum number of retransmissions that are allowed during the survival time.

6. The method of claim 1, wherein the transmit power level increase is based at least in part on a regular power adjustment value or a survival time power adjustment value associated with a transmit power control (TPC) command from the target device.

7. The method of claim 6, wherein the source device autonomously selects either the regular power adjustment value or the survival time power adjustment value associated with the TPC command to be used as the transmit power level increase.

8. The method of claim 6, wherein the source device selects either the regular power adjustment value or the survival time power adjustment value associated with the TPC command to be used as the transmit power level increase based at least in part on an indicator received from the target device.

9. The method of claim 8, wherein the indicator is a bit in the TPC command.

10. The method of claim 8, wherein the indicator is included in a medium access control control element received from the target device.

11. The method of claim 1, wherein the transmit power level increase is based at least in part on downlink control information (DCI) that includes a transmit power control (TPC) command to indicate a survival time power adjustment value.

12. The method of claim 11, wherein the DCI is scrambled by a radio network temporary identifier associated with indicating a survival time TPC command.

13. The method of claim 11, wherein the DCI has a group common DCI format to schedule the transmit power level increase for multiple source devices associated with a block number for an uplink in a cell associated with the target device.

14. The method of claim 11, wherein the TPC command includes one or more bits to indicate the survival time power adjustment value.

15. A source device for wireless communication, comprising:
a memory; and
one or more processors operatively coupled to the memory, the memory and the one or more processors configured to:
determine a transmit power level increase based at least in part on a failed transmission for a message having a deadline for reception at a target device, wherein the deadline for reception of the message is based at least in part on a survival time for an application consuming a communication service associated with the message; and
transmit a next message using the transmit power level increase during the survival time and prior to the deadline for reception of the message at the target device.

16. The source device of claim 15, wherein the transmit power level increase is applied only for a last transmission during the survival time.

17. The source device of claim 15, wherein the transmit power level increase is selected from multiple values for the transmit power level increase based at least in part a number of transmissions that have been attempted during the survival time.

18. The source device of claim 15, wherein the transmit power level increase is selected from multiple values for the transmit power level increase based at least in part a duration of the survival time.

19. The source device of claim 15, wherein the transmit power level increase is selected from multiple values for the transmit power level increase based at least in part a maximum number of retransmissions that are allowed during the survival time.

20. The source device of claim 15, wherein the transmit power level increase is based at least in part on a regular power adjustment value or a survival time power adjustment value associated with a transmit power control (TPC) command from the target device.

21. The source device of claim 20, wherein the source device autonomously selects either the regular power adjustment value or the survival time power adjustment value associated with the TPC command to be used as the transmit power level increase.

22. The source device of claim 20, wherein the source device selects either the regular power adjustment value or the survival time power adjustment value associated with the TPC command to be used as the transmit power level increase based at least in part on an indicator received from the target device.

23. The source device of claim 22, wherein the indicator is a bit in the TPC command.

24. The source device of claim 22, wherein the indicator is included in a medium access control control element received from the target device.

25. The source device of claim 15, wherein the transmit power level increase is based at least in part on downlink control information (DCI) that includes a transmit power control (TPC) command to indicate a survival time power adjustment value.

26. The source device of claim 25, wherein the DCI is scrambled by a radio network temporary identifier associated with indicating a survival time TPC command.

27. The source device of claim 25, wherein the DCI has a group common DCI format to schedule the transmit power level increase for multiple source devices associated with a block number for an uplink in a cell associated with the target device.

28. The source device of claim 25, wherein the TPC command includes one or more bits to indicate the survival time power adjustment value.

29. A non-transitory computer-readable medium storing a set of instructions for wireless communication, the set of instructions comprising:
one or more instructions that, when executed by one or more processors of a source device, cause the source device to:
determine a transmit power level increase based at least in part on a failed transmission for a message having a deadline for reception at a target device, wherein the deadline for reception of the message is based at least in part on a survival time for an application consuming a communication service associated with the message; and
transmit a next message using the transmit power level increase during the survival time and prior to the deadline for reception of the message at the target device.

30. An apparatus for wireless communication, comprising:
means for determining a transmit power level increase based at least in part on a failed transmission for a message having a deadline for reception at a target device, wherein the deadline for reception of the message is based at least in part on a survival time for an application consuming a communication service associated with the message; and
means for transmitting a next message using the transmit power level increase during the survival time and prior to the deadline for reception of the message at the target device.
